(19) United States
(12) Patent Application Publication
(10) Pub. No.: US 2010/0325348 A1
(43) Pub. Date: Dec. 23, 2010

(54) DEVICE OF FLASH MODULES ARRAY

(75) Inventors: Schumann Rafizadeh, Suzhou (CN); Paul Willmann, Suzhou (CN); Yiji Lin, Suzhou (CN); Ying Hu, Suzhou (CN)

Correspondence Address: HAMRE, SCHUMANN, MUELLER & LARSON, P.C., P.O. BOX 2902, MINNEAPOLIS, MN, 55402-0902, US

(73) Assignee: SUZHOU ONE WORLD TECHNOLOGY CO., LTD., Suzhou (CN)

(21) Appl. No.: 12/746,719

(22) PCT Filed: Jan. 18, 2008
(86) PCT No.: PCT/CN08/70135

§ 371 Date: Sep. 9, 2010

(30) Foreign Application Priority Data
Dec. 5, 2007 (CN) 200710171787.8

(51) Int. Cl. G06F 12/02; G06F 13/14

(52) U.S. Cl. 711/103; 710/305; 711/E12.008

(57) ABSTRACT

This invention provides a device of Flash Modules Array or Flash Array (FA) for short, with a higher capacity, higher speed and lower power consumption. A device of flash array comprises: a one or more physical I/O interfaces, for performing data transmission with the outside or upstream; one or more ports for flash modules consisting of multiple flash memory modules, a flash array controller, set between the physical I/O interface and the flash modules, further including: a block mapping unit, for performing the address mapping between the logical address which is transmitted between the physical I/O interface and the outside and the physical address which is transmitted between the physical I/O interface and the flash array. The invention is applied in the field of flexible solid state storage device.

### FIELD OF THE INVENTION

This invention relates to a flash-based storage device, and more particularly to utilize flash-based storage modules in an array format.

### BACKGROUND

Flash memory storage technology, such as NAND flash, has significant power-consumption and reliability advantages versus traditional magnetic disk-based storage. In portable and embedded systems, it is particularly advantageous to be able to minimize the power consumption of system components, including secondary storage. However, cycling between low-power and high-performance operation with traditional magnetic disk storage devices can prematurely ware out their moving parts, rendering the entire storage device inoperable. Thus, utilizing a flash-based storage to replace traditional disk-based storage such as hard drive disk is feasible.

However this meets a problem in the process of trying replacement. Flash-based storage suffers from limited capacity as compared to disk-based storage, and remains much more costly per unit of storage than disk in high-capacity modules. Moreover, when the capacity of flash memory becomes larger and larger, its access speed will be decreased.

Currently, the advances of HDD (Hard Disk Drive) storage technology are being exploited by flash based solid state storage devices which are designed and manufactured in the same form factors as replacement as direct replacement parts in computers, laptops and notebook computers. However, the limited life-cycle of flash does not lend itself to a direct replacement for high-capacity HDDs.

While the significant capacity enhancements for Hard Disk Storage devices were achieved as a result of Winchester technology which sealed in the HDAs to avoid contamination, the flash does not suffer from the same sensitivity to dust and contamination as there are no moving heads with extremely low distance to the rotating media of Disks.

For these reasons, the Flash Modules Array (FA) invention provides a quantum leap forward in solid state storage technology by providing a solution that allows varying number of off-the-shelf flash modules to be configured as a flexible configuration of high capacity flash solid state storage devices where users can reliably storage and retrieve high volumes of data at a much higher throughput bandwidth than possible without this innovation by prior art.

### SUMMARY

The purpose of this invention is to solve the problems mentioned above, and to provide a flash array device with higher capacity, higher speed and lower power consumption.

The technical implementation of the invention is: a device of flash array comprises:

one or more physical I/O interfaces, for performing data transmission with the outside or upstream;

one or more ports for flash modules consisting of multiple flash memory modules,

a flash array controller, set between the physical I/O interface and the flash modules; further including a block mapping unit, for performing the address mapping between the logical address which is transmitted between the physical I/O interface and the outside and the physical address which is transmitted between the physical I/O interface and the flash array.

The above device, which the flash memory modules are in parallel.

The above device, which the physical I/O interface includes one of the following among USB interface, SATA interface, eSATA interface and ATA interface.

The above device, which includes a printed circuit board that accommodates the controller of the flash array.

The above device, which includes an enclosure.

The above device, which the block mapping unit maps address in flash memory modules linearly.

The above device, which the block mapping unit maps address in flash memory modules in parallel.

This invention has following benefits compared to the existing technology: this invention utilizes multiple parallel flash memory modules as a flash array and establish mapping between logical address and physical address. The proposed device provides higher storage capacity compare to traditional flash-based device (such as flash cards), and faster accessing speed and lower power consumption compare to traditional magnetic disk-based storage device.

### BRIEF DESCRIPTION OF THE DRAWINGS

FIG. 1 is the implemented schematic figure of the device of flash array.

### PREFERRED EMBODIMENT OF THE PRESENT INVENTION

The further description of the invention with figure and implementation:

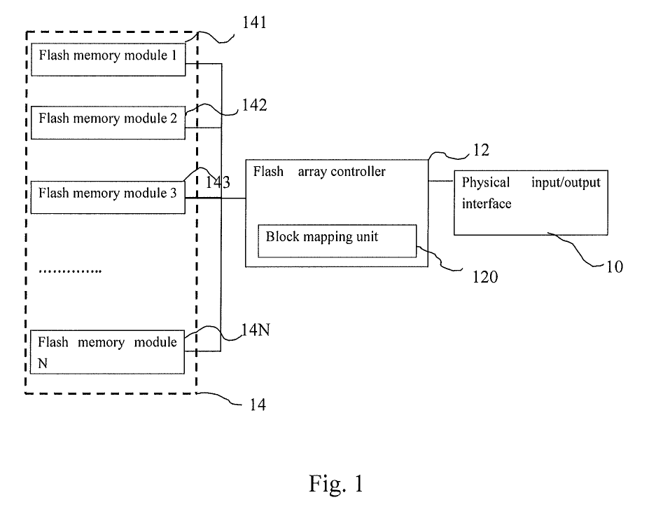

FIG. 1 presents a better implemented schematic of the invention. Refer to FIG. 1, the device of flash array 1 includes physical I/O interface 10, flash array controller 12, flash array 14. And the array device also includes the printed circuit board (no icon) to accommodate the flash array controller 12 and an enclosure (no icon). The block mapping unit 120 is set within the flash array controller 12. Flash array 14 consists of multiple flash memory modules from flash memory module 141, flash memory module 142 . . . to flash memory module 14N. It can be arranged in parallel as well as other ways.

Physical I/O interface 10 transfers data with outside, this kind of data transmission is based on the logical address. Outside includes storage device, read/write device, bus architecture etc. Physical I/O interface 10 includes one of USB interface, SATA interface, IDE interface, eSATA interface, and ATA interface. For example, when device 1 is connected with computer, interface 10 interacts with host's physical storage bus and converting host's I/O requests to logical read and write commands at runtime. Interface 10 also handles bus-specific commands, such as those for device discovery and initialization. Once storage-bus read and write commands have been received it will be interpreted by the device physical interface 10. The details of physical I/O interface 10 do not limit this invention.

Data receiving from logical address through physical I/O interface 10 need to be stored inside one of the flash memory module among flash array 14. Since interface 10 and inside each flash memory module are based on addressable physical address, block mapping unit 120 in flash array controller 12 is responsible for mapping this logical address to physical address. Data based on mapped physical address are stored in corresponding flash memory module. Similarly, when data stored in one of flash memory module are transferred to outside through interface 10, it also needs to be mapped from inside physical address to outside logical address through block mapping unit 120.

There are two kinds of mapping methods of block mapping unit 120. Block mapping unit 120 can treat the parallel flash memory modules as separate arrays of linearly addressable blocks. For example, if each flash memory module had a capacity of 256 blocks, module#0 would hold logical addresses 0 through 255, and module#1 would hold logical addresses 256 through 511 and so forth. But overall performance would still be limited to the throughput of any one single storage module for linear bulk-transfer operation.

Block mapping unit 120 can simultaneously access parallel flash memory modules. For example, if device 1 uses 4 parallel flash memory modules (that is N=4), and place logical block 0 on Module#0,logical block 1 on Module#1,logical block 2 on Module#2, and logical block 3 on Module#3,then the device can support an effective throughput rate of four times the base throughput of a single flash memory module. Presuming that N is the number of flash memory module, corresponding physical block position of logical address A is (A mod N) inside flash memory module. This has been used in hard disk mapping technology.

This invention can reach lower power consumption by replacing magnetic disk storage to flash memory storage. The capacity of flash memory storage is increased by utilizing multiple parallel flash memory modules as a flash array. The flash array can read and write data parallel from each flash memory module. For example, while part of the flash memory modules are reading and writing, the speed of flash memory storage can be increased by stopping data read/write on other flash memory modules. The above implementation of the invention provides technician of the same field to practice and use. Many modifications and variations are possible in light of the above teaching. It is intended that the scope of the invention be limited not by this detailed description, but rather by the claims appended hereto.

1. A device of flash array comprising:
one or more physical I/O interfaces, for performing data transmission with the outside or upstream;
one or more ports for flash modules consisting of multiple flash memory modules;
a flash array controller, set between the physical I/O interface and the flash modules; Further including:
a block mapping unit, for performing the address mapping between the logical address and the physical address.

2. The device of flash array of claim 1 wherein the flash memory modules are parallel.

3. The device of flash array of claim 2 wherein the physical I/O interface includes one of USB interface, SATA interface, eSATA interface, and ATA interface.

4. The device of flash array of claim 1 further comprising the printed circuit board accommodated with the flash array controller.

5. The device of flash array of claim 1 further comprising an enclosure.

6. The device of flash array of claim 2 wherein the block mapping unit maps address by treating the parallel flash memory modules as separate arrays of linearly addressable blocks.

7. The device of flash array of claim 2 wherein the block mapping unit maps address by simultaneously accessing parallel flash memory modules.
